(19) United States
(12) Patent Application Publication
(10) Pub. No.: US 2003/0155425 A1
(43) Pub. Date: Aug. 21, 2003

(54) CD smartcard

(76) Inventor: Jeffrey Thomas Lynch, Cronulla (AU)

Correspondence Address: Douglas B Teaney, Greenberg Traurig, Suite 2400, 77 West Wacker Drive, Chicago, IL, 60601, US

(21) Appl. No.: 10/203,684

(22) PCT Filed: Dec. 20, 2000
(86) PCT No.: PCT/AU00/01564

(30) Foreign Application Priority Data
Feb. 11, 2000 (AU) PQ 5580

(51) Int. Cl. G06K 19/06

(52) U.S. Cl. 235/492

(57) ABSTRACT

A smart card (10) has a smart chip (11) embedded therein. The smart chip (11) has contained therein a data memory means such that data is able to be written to or read from the smart ship (11) using a smart card reader, characterised by a further data storage means (12) is provided on the smart card (10) whereby data is a able to be written to or read from this further data storage means by a CD, DVD or like device.

The present invention relates to cards which can be fitted with a smart card chip or cards fitted with a magnetic strip, or cards using a combination of both a smart card chip and a magnetic strip. In particular, the invention relates cards which includes the provision of a CD ROM or DVD formatted memory which can contain information which can be read and displayed by the appropriate devices. A smart chip is defined as a memory or microprocessor chip in both contact and contactless formats

The invention also relates to an adaptor designed to hold the CD smart card such that it can be read and displayed by the appropriate device such as a CD reader.

### BACKGROUND TO THE INVENTION

A smart card is a credit card sized card which contains a memory or microprocessor chip with information contained thereon such that the card can be used in an appropriate smart card reading device to access a variety of purpose written applications containing data or information which can be viewed, updated, downloaded when interfaced with an appropriate piece of equipment such as a computer, mobile phone or other hand-held devices fitted with a reading device. A smart card can also be used in an appropriate device to purchase goods or services in a traditional selling environment and in e-commerce and m-commerce applications using the internet or wireless environments.

There is a universal standard for the operation of smart cards, such that smart card readers are standardised and therefore the positioning of the chip on the smart card and magnetic strip is also standardised. The size of the smart card is standardised a that of the standard (credit card with its length, width and thickness being such that they are all able to be used in all smart card reading devices.

It is also known to have so-called CD-ROM business cards, whereby a business card which is similar in size to that of a standardised credit card can have information applied to it such that the CD-ROM card can be played in a CD-ROM reader on a computer, CD player, or the like. Such CD-ROM business cards to be able to be played in a CD-ROM reader or the like are required to have guides such that the substantially rectangular business card is able to be read in a reader which is used to read circular CDs.

Known CD-ROM business cards having the guides as described above such that they can be played in CD-ROM player are unable to be used as a smart card as the dimensions of the CD-ROM business card inclusive of the guides as described above does not allow the card to be read with in a smart card reader.

Therefore the invention requires a specially engineered CD-ROM to be manufactured to which when inserted into the specially engineered adaptor allows the CD-Smart card to function normally when used in a CD-ROM player.

There is currently no smart card available to the public which has the provision of an extra storage arrangement suitable for holding information, whether that information is for the use of the user of the smart card or the supplier of the service to which the smart card is being used. Such a smart card can therefore be used in situations previously not envisaged

It is therefore seen to be desirable to have a smart card which has the provision of an extra information storage arrangement which allows the users and suppliers of goods and services the opportunity to increase the efficiency of the smart card with the provision of extra services a availability.

### OBJECT OF THE INVENTION

It is an object of the present invention to provide a smart card which provides the above mentioned advantages. At the very least, the object of the invention is to provide an alternative to known smart cards.

### DISCLOSURE OF THE INVENTION

According to one aspect of the present invention there is disclosed a smart card having a smart chip embedded therein, whereby ie smart chip has contained therein a data memory means such that data is able to be written to or read from the smart chip using a smart card reader, characterised by a further data storage means being provided on the smart card whereby data is a able to be written to or read from this further data storage means by a CD, DVD or like device.

Preferably, the smart card has standardized dimensions so that it can be located and held securely in position with the adaptor. The adaptor acts as a guide means to ensure that the CD smart card is centred in the CD, DVD or like device so that the data can be read.

The adaptor is preferably circular in shape, 12 cm in diameter and locates into the CD/DVD carriage of any standard CD drive.

The adaptor is also shaped such that the CD is able to operate in a PC, ie it has two rounded ends equally 12 cm with two other sides which are straight and parallel to maintain balance.

### BRIEF DESCRIPTION OF THE DRAWINGS

The present invention will be now be described with reference to the accompanying drawing in which:

FIG. 1 is a view of a smart card according to a preferred embodiment of the present invention;

FIG. 2 is a view of a smart card according to another embodiment of the present invention;

FIG. 3 is an elevational view of the smart card according to FIGS. 1 and 2;

FIG. 4 is a reverse side view of a smart card with a magnetic strip according to another embodiment of the present invention,

FIG. 5 is a view of an adapotor to receive a smart card according to of the present invention;

FIG. 6 is a view of an adaptor according to another embodiment of the present invention; and

FIG. 7 is a view of a contactless smart card according to another preferred embodiment of the present invention.

### BEST MODE OF CARRYING OUT THE INVENTION

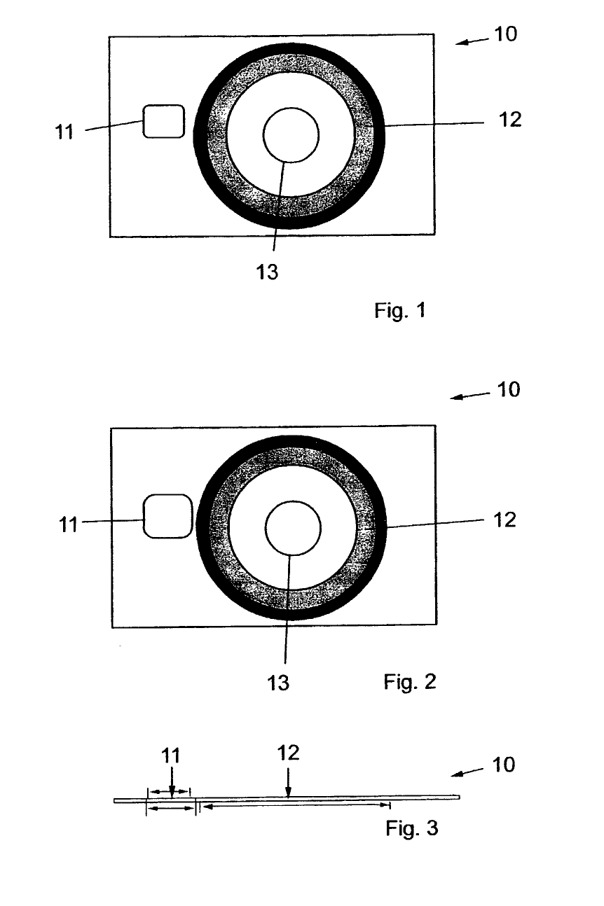

Smart card 10 of the preferred embodiments is illustrated in FIGS. 1, 2, 3 and 4 of the drawings. The smart card 10 is able to be used in smart card readers (not illustrated) as well as be used in CD, DVD or like device readers (not illustrated).

The smart card 10 has the standardised dimensions of a smart card such that it can be used in a smart card reader with its smart chip 11 embedded in the standard position on the smart card 10. The smart chip 11 has the usual data applicable thereto.

The smart card 10 also has a further data storage means by the provision of an annular data area 12 suitable to be read by CD, DVD or like device readers. The smart card 10 has a circular hole 13 located offset from its centre in order that it can be held in an adaptor whilst being rotated in the CD, DVD or like device readers. As the smart card is rectangular, the annular data area 12 is arranged such that the data can be continuously read, ie all the annular data area 12 is located within the edges of the smart card 10.

It is seen from the drawings that the thickness of the smart card is substantially uniform in order that it can be received and read in smart card readers.

It is seen that the smart chip 11 is position adjacent the annular data area 12 but they do not interfere or react against each other

As seen from the drawings, there are three embodiments of the smart card 10. In FIG. 1, a memory CD smart card 10 has an annular data area 12 with the same dimensions as that of a microprocessor CD smart card 10 which has a larger size of the smart chip 11 as seen in FIG. 2.

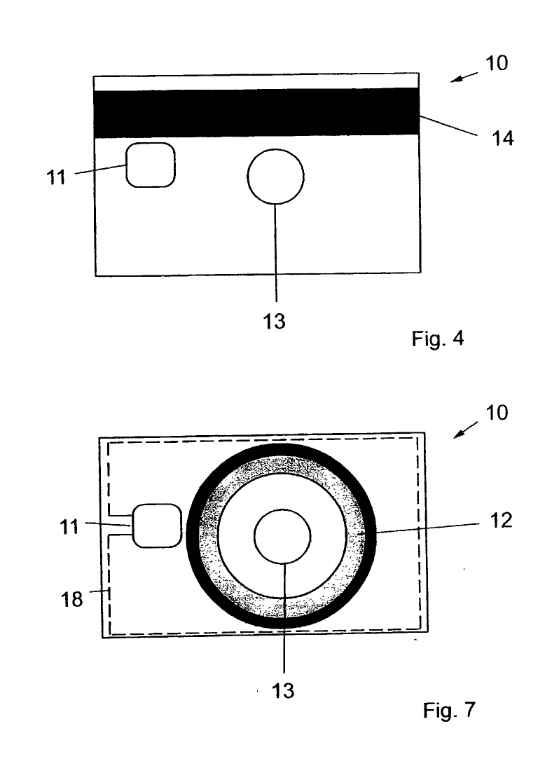

The smart card 10 as illustrated in FIG. 4 also has a magnetic strip 14 in conjunction with the chip 11. All different combinations are within the scope of the present invention.

The CD smart card of the preferred embodiments can be used as a smart card as well as containing valuable information to the user or the supplier. The information in the CD portion can be used in conjunction with that contained in the smart chip 11 to provide greater potential for the dissemination of data and information.

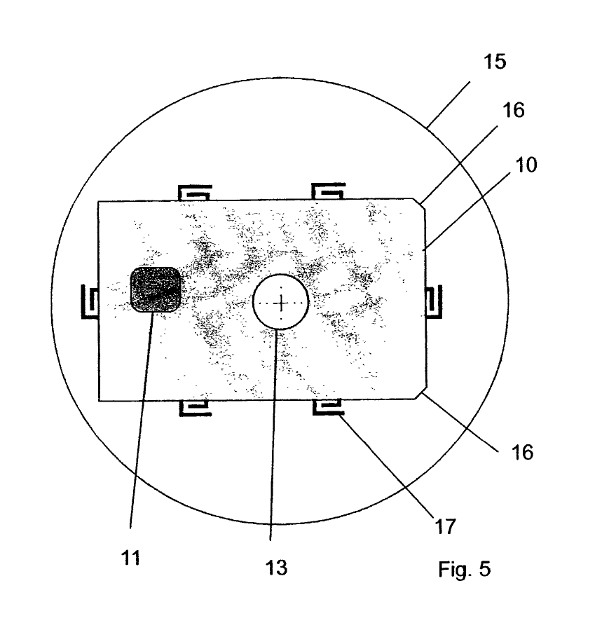

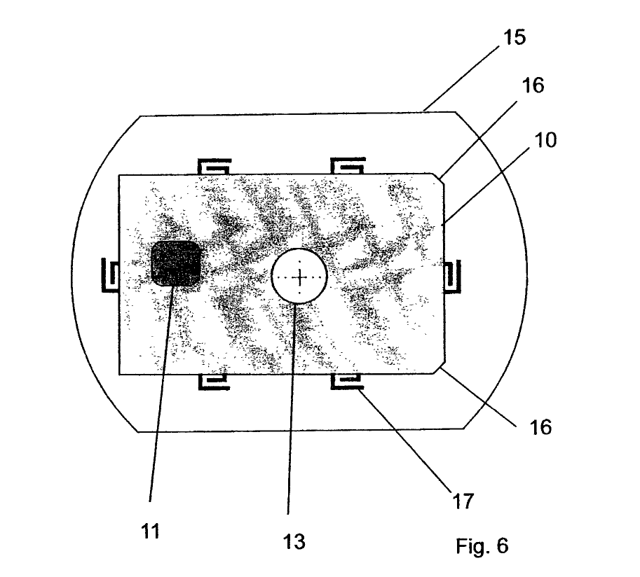

Preferably, the smart card has standardised dimensions so that it can be located and held securely in position with an adaptor 15 as illustrated in FIGS. 5 and 6 and as seen in an offset manner. The adaptor acts as a guide means to ensure that the CD smart card is centred in the CD, DVD or like device so that the data can be read.

The adaptor 15 is preferably circular in shape, 12 cm in diameter and locates into the CD/DVD carriage of any standard CD drive.

The adaptor 15 is also shaped such that the CD is able to operate in a PC, ie it has two rounded ends equally 12 cm with two other sides which are straight and parallel to maintain balance as seen in FIG. 6.

The adaptor 15 has locating points 16 whereby the smart card 10 is received thereunder, the locating points being lips under which the card 10 is located. Securing clips 17 are used to secure the smart card in that position.

Another embodiment is illustrated in FIG. 7 whereby a CD smartcard 10 has a contactless chip 11 with an antenna 18. Naturally other configurations of the antenna are within the scope of the present invention.

The foregoing describes only some embodiments of the present invention, and modifications obvious to those skilled in the art can be made thereto without departing from the scope of the present invention.

1. A smart card having a smart chip embedded therein, whereby the smart chip has contained therein a data memory means such that data is able to be written to or read from the smart chip using a smart card reader, characterised by a further data storage means being provided on the smart card, said further data storage means being an annular CD type storage means with a centre hole located therein whereby data is a able to be written to or read from this further data storage means by a CD, DVD or like device, wherein the smart card has standardised dimensions so that it can be located and held securely in position within an adaptor, the adaptor acting as a guide means to ensure that the CD smart card is centred in the CD, DVD or like device so that the data can be read, wherein the centre hole of the smart card is located at the centre of the smart card and adaptor combination but offset from the centre of the smart card.

2. The smart card according to claim 1, wherein the adaptor is circular in shape and locates into the CD/DVD carriage of any standard CD drive.

3. The smart card according to claim 1, wherein the adaptor is shaped such that the CD is able to operate in a PC, ie it has two rounded ends with two other sides which are straight and parallel to maintain balance.

4. The smart card according to claims 2 or 3, wherein the adaptor has locating means to secure the card therein.

5. The smart card according to claim 4, wherein the locating means consist of locating points whereby the smart card is received thereunder, the locating points being lips under which the card is located, and securing clips are used to secure the smart card in that position.

6. The smart card according to any one of the preceding claims, wherein a rectangular magnetic strip is also applied to the card.

7. The smart card according to any one of the preceding claims, wherein the chip is in contactless form and has an antenna for communication with other devices.
